(19) United States
(12) Patent Application Publication
(10) Pub. No.: US 2026/0286161 A1
(43) Pub. Date: Sep. 24, 2026

(54) METHOD FOR PRODUCING CONDUCTIVE PIGMENT PASTE AND METHOD FOR PRODUCING MIXTURE PASTE

(71) Applicant: KANSAI PAINT CO., LTD., Amagasaki-shi, Hyogo (JP)

(72) Inventors: Kogo KINOSHITA, Hiratsuka-shi, Kanagawa (JP); Shinjiro GOTO, Hiratsuka-shi, Kanagawa (JP)

(21) Appl. No.: 19/167,944

(22) PCT Filed: Mar. 26, 2024
(86) PCT No.: PCT/JP2024/011891

§ 371 Date: Sep. 23, 2025

(30) Foreign Application Priority Data
Mar. 27, 2023 (JP) 2023-049366

(51) Int. Cl. C09D 17/00; C09C 1/44; C09D 5/24; C09D 7/20; C09D 7/63; C09D 139/06; H01B 1/24; H01M 4/505; H01M 10/0525

(52) U.S. Cl. CPC C09D 17/004; C09C 1/44; C09D 5/24; C09D 7/20; C09D 7/63; C09D 17/002; C09D 139/06; H01M 4/505; H01B 1/24; H01M 10/0525

(57) ABSTRACT

A method for producing a conductive pigment paste having excellent pigment dispersibility and storage stability, which contains a pigment dispersing resin (A), a conductive pigment (B), a solvent (C), and a fluorocarbon resin (D) that can be included as needed, includes a step of sequentially performing Step 1: a step of pulverizing a conductive pigment composition containing the conductive pigment (B) at a pigment concentration of 50 mass % or more with a pulverizer, and Step 2: a step of mixing the conductive pigment composition obtained in the step 1 with components including the pigment dispersing resin (A), the solvent (C), and the fluorocarbon resin (D) that can be optionally included, and performing dispersion.

### TECHNICAL FIELD

The present invention relates to a method for producing a conductive pigment paste excellent in conductivity, pigment dispersibility, and storage stability even at a high pigment concentration, a method for producing a mixture paste, and a method for producing a battery electrode layer having high battery performance.

### BACKGROUND ART

In the related art, pasty pigment dispersions obtained by dispersing a pigment in a mixture of a pigment dispersing resin, a solvent, and the like have been widely used in the fields of paints, battery electrodes, coating materials, electromagnetic shields, display panels, touch-screen panels, colored films, colored sheets, decorative materials, protective materials, magnet-modifying materials, printing inks, device members, electronic equipment members, printed wiring boards, solar cells, functional rubber members, molded resin films, and the like. Furthermore, to provide these materials with properties such as electrostatic application properties, conductivity, electromagnetic shielding properties, and antistatic properties, conductive pigments, conductive polymers, and the like have been incorporated.

In these fields, improvements in properties such as pigment dispersibility, storage stability, conductivity, coatability, and finish quality have been increasingly demanded. Accordingly, pigment dispersing resins and pigment pastes having high pigment dispersion capability and high pigment dispersion stability sufficient to prevent reaggregation of pigment particles in formed pigment dispersions have been under development.

In designing a pigment paste, for a pigment dispersing resin not to adversely affect the conductive performance, etc. of an end product itself, such as a coating film, or from the viewpoint of reducing the amount of solvent and pigment dispersing resin used and reducing the amount of energy used in drying, it is important to produce a pigment paste in which a pigment is densely and uniformly dispersed with a small amount of pigment dispersing resin.

For example, PTL 1 discloses a method for producing a nonaqueous electrolyte battery electrode, the method including a step of kneading a carbonaceous conductive agent and a dispersing solvent and then dispersing the carbonaceous conductive agent using a medium-type disperser, a step of adding an active material and a binder to a paste obtained in the previous step and kneading them to provide an active material paste, and a step of applying the active material paste to an electrode substrate.

However, according to this invention, in the case of a paste having a high pigment concentration and/or a high viscosity, there have been cases where uniform dispersion cannot be achieved and storage stability is poor.

### CITATION LIST

### Patent Literature

PTL 1: Japanese Unexamined Patent Application Publication No. 10-144302

### SUMMARY OF INVENTION

### Technical Problem

An object of the present invention is to provide a method for producing a conductive pigment paste that is excellent in pigment dispersibility and storage stability even when it is a paste having a high pigment concentration and/or a high viscosity and a method for producing a mixture paste, and another object is to provide a method for producing a coating film (battery electrode layer) excellent in finish quality, conductivity, etc.

### Solution to Problem

As a result of intensive studies to solve the above problems, the present inventors have found that the above problems can be solved by a method for producing a conductive pigment paste containing a pigment dispersing resin (A), a conductive pigment (B), a solvent (C), and a fluorocarbon resin (D) that can be optionally included, the method including a step of sequentially performing
Step 1: a step of pulverizing a conductive pigment composition containing the conductive pigment (B) at a pigment concentration of 50 mass % or more with a pulverizer, and
Step 2: a step of mixing the conductive pigment composition obtained in the step 1 with components including the pigment dispersing resin (A), the solvent (C), and the fluorocarbon resin (D) that can be optionally included, and performing dispersion,
thereby completing the present invention.

Thus, the present invention provides a method for producing a conductive pigment paste, a method for producing a mixture paste, and a method for producing a battery electrode layer described below.
Item 1.

A method for producing a conductive pigment paste containing a pigment dispersing resin (A), a conductive pigment (B), a solvent (C), and a fluorocarbon resin (D) that can be optionally included, the method including a step of sequentially performing
Step 1: a step of pulverizing a conductive pigment composition containing the conductive pigment (B) at a pigment concentration of 50 mass % or more with a pulverizer, and
Step 2: a step of mixing the conductive pigment composition obtained in the step 1 with components including the pigment dispersing resin (A), the solvent (C), and the fluorocarbon resin (D) that can be optionally included, and performing dispersion.
Item 2.

The method for producing a conductive pigment paste according to Item 1, wherein the conductive pigment (B) contains a carbon nanotube (B1).
Item 3.

The method for producing a conductive pigment paste according to Item 2, wherein the carbon nanotube (B1) before and after the pulverizing in the step 1 satisfies (1) and (2) below;
(1) a G/D ratio of the carbon nanotube (B1) before the pulverizing, where G is a maximum peak intensity in a range of 1560 cm⁻¹ or more and 1600 cm⁻¹ or less, and D is a maximum peak intensity in a range of 1310 cm⁻¹ or more and 1350 cm⁻¹ or less, is 0.1 or more and 5.0 or less, (2) when the G/D ratio of the carbon nanotube (B1) before the pulverizing is a, and a G/D ratio of the carbon nanotube (B1) after the pulverizing is β, β/α<1.00 holds.
Item 4.

The method for producing a conductive pigment paste according to any one of Items 1 to 3, wherein the pigment dispersing resin (A) has at least one alkyl group having 12 or more carbon atoms.
Item 5.

The method for producing a conductive pigment paste according to any one of Items 1 to 4, wherein the pigment dispersing resin (A) has at least one polar functional group selected from the group consisting of an amide group, an imide group, a hydroxyl group, a carboxyl group, a sulfonic acid group, a phosphoric acid group, a silanol group, a cyano group, a pyrrolidone group, and an amino group, and the pigment dispersing resin (A) has a polar functional group concentration of 0.3 mmol/g to 23 mmol/g.
Item 6.

The method for producing a conductive pigment paste according to any one of Items 1 to 5, wherein the conductive pigment paste contains the fluorocarbon resin (D), and a step of mixing the fluorocarbon resin (D) includes a step of mixing and dissolving the fluorocarbon resin (D) in advance with a solvent having a liquid temperature of 40° C. or higher or includes a step of mixing the fluorocarbon resin (D) with a solvent and then performing heating to a temperature of 40° C. or higher.
Item 7.

The method for producing a conductive pigment paste according to any one of Items 1 to 6, wherein the solvent (C) is N-methyl-2-pyrrolidone.
Item 8.

The production method according to any one of Items 1 to 7, wherein the step 2 includes a step of sequentially performing
Step 2-1: a step of adding the components into a disperser, the components including the conductive pigment composition in an amount of 70 mass % or less based on 100 mass % of a total amount of the conductive pigment composition contained in the conductive pigment paste obtained after dispersion, and performing dispersion treatment, and
Step 2-2: a step of adding the conductive pigment composition into the disperser until a desired concentration is reached, and performing dispersion treatment.
Item 9.

A method for producing a mixture paste for a lithium ion secondary battery, the method including
Step 3: a step of mixing at least one electrode active material (F)
further with a conductive pigment paste obtained by the method for producing a conductive pigment paste according to any one of Items 1 to 8.
Item 10.

A method for producing an electrode layer for a lithium ion secondary battery, the method including a step of applying a mixture paste for a lithium ion secondary battery obtained by the production method according to Item 9 to a current collector.
Item 11.

A method for producing an electrode for a lithium ion secondary battery, the method including a step of applying an electrode insulating portion to an end portion or an upper layer of an electrode layer obtained by the method for producing an electrode layer for a lithium ion secondary battery according to Item 10.

### Advantageous Effects of Invention

The method for producing a conductive pigment paste and the method for producing a mixture paste according to the present invention are excellent in pigment dispersibility and storage stability even at a high pigment concentration and/or a high viscosity and can sufficiently reduce the viscosity of a paste with a relatively small amount of dispersing resin. A coating film (battery electrode layer) thereof is excellent in finish quality, conductivity, battery performance, etc.

### DESCRIPTION OF EMBODIMENTS

Hereinafter, embodiments of the present invention will be described in detail.

It should be appreciated that the present invention is not limited to the following embodiments and includes various modifications practiced without departing from the gist of the present invention.

In the present invention, a composition containing a conductive pigment (B) at a pigment concentration of 50 mass % or more and obtained by pulverization with a pulverizer is referred to as a “conductive pigment composition”.

A paste prepared by further blending the conductive pigment composition with at least one pigment dispersing resin (A), a solvent (C), a fluorocarbon resin (D) that can be optionally included, and various other optional components is referred to as a “conductive pigment paste”.

The “conductive pigment paste” is a paste containing a conductive pigment and does not mean that the paste itself has conductivity.

It can be said that the conductive pigment paste is a paste containing substantially no electrode active materials.

A paste prepared by further blending at least one electrode active material and various other optional components in order to apply the conductive pigment paste is referred to as a “mixture paste”. A product obtained by application of the mixture paste to a coating target and drying is referred to as a “coating film” or a “mixture layer”.

When the coating film is used in a battery electrode, it can also be referred to as an “electrode layer”.

A carbon nanotube can also be abbreviated as a “CNT”.

### [Method for Producing Conductive Pigment Paste]

The present invention is a method for producing a conductive pigment paste containing a pigment dispersing resin (A), a conductive pigment (B), a solvent (C), and a fluorocarbon resin (D) that can be optionally included, and is a method for producing a conductive pigment paste containing the conductive pigment (B) in a well-dispersed state by a step of first pulverizing the conductive pigment (B) at a pigment concentration of 50 mass % or more with a pulverizer to obtain a conductive pigment composition (step 1: pulverization step), and a step of mixing the conductive pigment composition obtained in the step 1 with components including the pigment dispersing resin (A), the solvent (C), and the fluorocarbon resin (D) that can be optionally included, and performing dispersion (step 2: dispersion step).

The present invention may include another step between, before, or after the step 1 and the step 2.

### Step 1 (Pulverization Step)

The step 1 is a step of pulverizing (including disintegrating) the conductive pigment (B) with a pulverizer to obtain a conductive pigment composition, and the pigment concentration of the conductive pigment (B) is typically 50 mass % or more, preferably 80 mass % or more, more preferably 90 mass % or more, still more preferably 95 mass % or more, particularly preferably 99 mass % or more, further particularly preferably 100 mass %, based on 100 mass % of the conductive pigment composition. The “pigment concentration of the conductive pigment (B)” is the pigment concentration of the conductive pigment (B) contained in the conductive pigment composition, and pigments other than the conductive pigment (B) and solids are not included.

As components other than the conductive pigment (B) in the conductive pigment composition, solvents, resins, pigments other than the conductive pigment (B), and others described later can be suitably used.

The solid concentration of the conductive pigment composition is typically 50 mass % or more, preferably 80 mass % or more, more preferably 90 mass % or more, still more preferably 95 mass % or more, particularly preferably 99 mass % or more, further particularly preferably 100 mass, based on 100 mass % of the conductive pigment composition. The “solid concentration” is the percentage (mass %) of a solid obtained when 1 g of a sample is dried by heating at 130° C. for 3 hours.

The conductive pigment composition obtained in the step 1 may contain components other than the conductive pigment (B) as long as the pigment concentration and the solid concentration above are satisfied, and can contain, for example, the pigment dispersing resin (A), pigments other than the conductive pigment (B), the solvent (C), and the fluorocarbon resin (D) that can be optionally included, which will be described later. The conductive pigment composition preferably contains substantially only the conductive pigment (B), and particularly preferably contains substantially only a carbon nanotube (B1).

The conductive pigment paste, when used for an electrode layer, preferably does not substantially contain an electrode active material described later because it is mixed in the subsequent step (step 3).

### Conductive Pigment (B)

The conductive pigment (B), which is a pigment having conductivity, may be a conductive pigment known per se, and preferably contains the carbon nanotube (B1). The conductive pigment (B) may further contain any other conductive pigment (B2) other than the carbon nanotube (B1).

The content of the carbon nanotube (B1) in the conductive pigment (B) is, for example, 50 mass % or more, preferably 75 mass % or more, more preferably 95 mass % or more, particularly preferably 99 mass % or more, further particularly preferably 100 mass %, based on 100 mass % of the conductive pigment (B).

### Carbon Nanotube (B1)

The carbon nanotube (B1) may be either a single-walled carbon nanotube or a multi-walled carbon nanotube, or a combination thereof. Particularly in terms of viscosity, conductivity, and cost, it is preferable to use a multi-walled carbon nanotube.

When the carbon nanotube (B1) is used, its content is, for example, 0.5 mass % or more, preferably 1 mass % or more, more preferably 2 mass % or more, and is, for example, 10 mass % or less, preferably 7 mass % or less, more preferably 6 mass % or less, based on 100 mass % of the total amount of the conductive pigment paste.

The content of the carbon nanotube (B1) is, for example, 5 mass % or more, preferably 10 mass % or more, more preferably 20 mass % or more, and is, for example, 90 mass % or less, preferably 70 mass % or less, more preferably 50 mass % or less, based on 100 mass % of the total solid content of the conductive pigment paste.

The average outer diameter of the carbon nanotube (B1) is, for example, 1 nm or more, preferably 3 nm or more, more preferably 5 nm or more, and is, for example, 30 nm or less, preferably 28 nm or less, more preferably 25 nm or less.

The average length of the carbon nanotube (B1) is, for example, 0.1 μm or more, preferably 1 μm or more, more preferably 5 μm or more, and is, for example, 100 μm or less, preferably 80 μm or less, more preferably 60 μm or less.

The BET specific surface area of the carbon nanotube (B1) is typically 100 m²/g or more, preferably 130 m²/g or more, more preferably 160 m²/g or more, and is typically 800 m²/g or less, preferably 600 m²/g or less, more preferably 400 m²/g or less, in terms of viscosity and conductivity.

The BET specific surface area in the present invention can be determined by a BET method using nitrogen adsorption measurement. Specifically, for example, the BET specific surface area (m²/g) can be measured in accordance with JIS Z 8830:2013 using a specific surface area meter (BERSORP-MAX (MicrotracBEL Corp.)).

The acidic group content of the carbon nanotube (B1) is typically 0.01 mmol/g or more, preferably 0.01 mmol/g or more, and is typically 1.0 mmol/g or less, preferably 0.5 mmol/g or less, more preferably 0.2 mmol/g or less, still more preferably 0.1 mmol/g or less, from the viewpoint of dispersibility and storability. An acidic group content of 0.01 mmol/g or more leads to good dispersibility, and an acidic group content of 1.0 mmol/g or less leads to good storability.

The acidic group can be introduced by the following acid treatment of the carbon nanotube.

### (Acid Treatment Method)

The method of the acid treatment is not particularly limited as long as an acid can be brought into contact with the carbon nanotube, and immersion of the carbon nanotube in an acid treatment liquid (aqueous acid solution) is preferred. Examples of the acid contained in the acid treatment liquid include, but are not limited to, nitric acid, sulfuric acid, and hydrochloric acid. These can be used alone or in combination of two or more. Of these, nitric acid and sulfuric acid are preferred.

The acidic group content of the carbon nanotube can be adjusted by, for example, the concentration, temperature, and treatment time of the acid treatment liquid.

After the acid treatment, an excess acid component adhering to the surface is removed by a washing method described below, whereby an acid-treated carbon nanotube can be obtained.

The method of washing the carbon nanotube subjected to the acid treatment is not particularly limited, and washing with water is preferred. For example, the carbon nanotube is recovered by a known method, such as filtration, from the carbon nanotube subjected to the acid treatment, and then the carbon nanotube is washed with water. After the washing, the water attached to the surface is, for example, removed by drying as required, whereby the acid-treated carbon nanotube can be obtained.

The median diameter (D50) of the carbon nanotube (B1) on a volume basis, when measured by a method described in EXAMPLES given later, is typically 10 μm or more, preferably 15 μm or more, more preferably 20 μm or more, and is typically 250 μm or less, preferably 200 μm or less, more preferably 150 μm or less. Here, the median diameter (D50) can be determined by irradiating particles of the carbon nanotube with laser light and converting the diameter of the carbon nanotube into a spherical shape based on the scattered light. Larger median diameters (D50) mean that more carbon nanotube aggregates are present and dispersibility is poorer. When the median diameter (D50) is larger than 250 μm, carbon nanotube aggregates are highly likely to be present in an electrode, leading to non-uniform conductivity across the electrode. When the median diameter (D50) is smaller than 10 μm, the conductive path is insufficient due to the short fiber length, leading to low conductivity. When the median diameter (D50) is in the range of 10 μm or more and 250 μm or less, the carbon nanotube can be uniformly dispersed in the electrode while maintaining conductivity.

In a Raman spectrum of the carbon nanotube (B1), a G/D ratio, where G is a maximum peak intensity in the range of 1560 cm⁻¹ or more and 1600 cm⁻¹ or less, and D is a maximum peak intensity in the range of 1310 cm⁻¹ or more and 1350 cm⁻¹ or less, is typically 0.1 or more, preferably 0.4 or more, more preferably 0.6 or more, and is typically 5.0 or less, preferably 3.0 or less, more preferably 1.0 or less.

Here, when the G/D ratio is in the range of 0.1 or more and 5.0 or less, the numbers of carbon surface defects and crystal grain boundaries are small, and conductivity tends to be high, which is preferred.

When the carbon nanotube (B1) is used as the conductive pigment (B), the carbon nanotube (B1) before and after the pulverizing in the step 1 preferably satisfies (1) and (2) below.
(1) A G/D ratio of the carbon nanotube (B1) before the pulverizing, where G is a maximum peak intensity in the range of 1560 cm⁻¹ or more and 1600 cm⁻¹ or less, and D is a maximum peak intensity in the range of 1310 cm⁻¹ or more and 1350 cm⁻¹ or less, is 0.1 or more and 5.0 or less.
(2) When the G/D ratio of the carbon nanotube (B1) before the pulverizing is a, and a G/D ratio of the carbon nanotube (B1) after the pulverizing is β, β/α<1.00 holds.

The value of β/α decreases as the pulverizing proceeds, and typically β/α<1.00, preferably 0.50<β/α<1.00, more preferably 0.70<β/α<0.98, still more preferably 0.90<β/α<0.96.

When β/α is within this range, the pulverized surface is moderately activated in a relatively short pulverization time, good dispersibility and storage stability are provided in the step 2 described later, that is, the dispersion step, and a coating film thereof can be provided with high conductivity and high finish quality.

### Other Conductive Pigment (B2)

The other conductive pigment (B2) other than the carbon nanotube (B1) may be, for example, at least one conductive carbon selected from the group consisting of acetylene black, ketjen black, furnace black, thermal black, graphene, and graphite. Preferred are one or more selected from the group consisting of acetylene black, ketjen black, furnace black, and thermal black, more preferred are one or more selected from the group consisting of acetylene black and ketjen black, and still more preferred is acetylene black.

The average primary particle diameter of the other conductive pigment (B2) is, for example, 10 nm or more, preferably 20 nm or more, and is, for example, 80 nm or less, more preferably 70 nm or less. Herein, the term “average primary particle diameter” refers to an average particle diameter of primary particles determined as follows: the conductive pigment (B2) is observed under an electron microscope; projected areas of 100 particles are determined; diameters of imaginary circles having areas equal to the projected areas are determined; and the diameters of the 100 particles are simply averaged. When the pigment is in an aggregated state, calculations are conducted using primary particles constituting an aggregate particle.

The BET specific surface area of the other conductive pigment (B2) is not particularly limited. In terms of viscosity and conductivity, it is, for example, 1 m²/g or more, preferably 10 m²/g or more, more preferably 20 m²/g or more, and is, for example, 500 m²/g or less, preferably 250 m²/g or less, more preferably 200 m²/g or less.

The dibutyl phthalate (DBP) absorption of the other conductive pigment (B2) is not particularly limited. In terms of pigment dispersibility and conductivity, it is, for example, 60 ml/100 g or more, preferably 150 ml/100 g or more, and is, for example, 1,000 ml/100 g or less, preferably 800 ml/100 g or less.

### Pulverization Method and Pulverizer

The conductive pigment (B) is pulverized (including disintegrated) with a pulverizer. In the present invention, particularly, a carbon nanotube is preferably contained as the conductive pigment (B).

In the step 1, that is, the pulverization step, pulverization is carried out using a pulverizer containing pulverization media (also referred to as media) such as glass beads, zirconia beads, or steel balls. The pulverization is carried out utilizing a pulverization force or a destruction force resulting from collision between the pulverization media and/or collision between the pulverizer and the pulverization media. As the pulverization device, a known pulverization device such as a high-speed rotary impact mill, a jet mill, a roll mill, an attritor, a ball mill, a vibration mill, or a bead mill can be used.

During the pulverization, various types of vapor or gas can be blown into the pulverizer to further activate the surface of the conductive pigment (B) or adjust the activity. The vapor is preferably an acidic or basic compound or the like, and the gas is preferably oxygen, nitrogen, or the like.

The pulverization is preferably carried out by so-called dry dispersion. Here, the “dry dispersion” refers to pulverizing a pigment substantially without containing a liquid component, and enables highly efficient and powerful pulverization (disintegration) because energy can be directly applied to the pigment. In addition, since the pulverized surface is activated and interacts with surrounding substances, good dispersibility and storage stability are provided in the step 2 described later, that is, the dispersion step, and a coating film thereof can be provided with high conductivity and high finish quality.

The outer diameter of the pulverization media is preferably 0.1 to 5 mm, more preferably 0.5 to 3 mm. Within this range, a desired pulverization force is provided, and the pigment can be efficiently pulverized and disintegrated without excessively destroying the fiber shape when the conductive pigment (B) is a carbon nanotube.

### Step 2 (Dispersion Step)

The step 2 is a step of mixing the conductive pigment composition obtained in the step 1 with components including the pigment dispersing resin (A), the solvent (C), and the fluorocarbon resin (D) that can be optionally included, and performing dispersion, and the step 2 can provide a liquid conductive pigment paste.

The upper limit of the solid concentration of the conductive pigment paste is typically less than 80 mass %, preferably less than 50 mass %, more preferably less than 20 mass %, still more preferably less than 10 mass %. The lower limit is typically 0.1 mass % or more, preferably 0.5 mass % or more, more preferably 1 mass % or more, still more preferably 2 mass % or more.

The conductive pigment paste is a paste of a conductive pigment containing the pigment dispersing resin (A), the conductive pigment (B), the solvent (C), and the fluorocarbon resin (D) that can be optionally included. The pigment dispersing resin (A) preferably has at least one polar functional group selected from the group consisting of an amide group, an imide group, a hydroxyl group, a carboxyl group, a sulfonic acid group, a phosphoric acid group, a silanol group, a cyano group, a pyrrolidone group, and an amino group, and the pigment dispersing resin (A) preferably has a polar functional group concentration of 0.3 mmol/g or more and 23 mmol/g or less.

Furthermore, the conductive pigment paste preferably contains a highly polar low-molecular-weight component (E) as required.

In the step 2, that is, the dispersion step, the components described above are uniformly mixed and dispersed using, for example, a conventionally known disperser such as a paint shaker, a sand mill, a ball mill, a pebble mill, an LMZ mill, a DCP pearl mill, a planetary ball mill, a homogenizer, a twin-screw kneader, or a thin-film spin system high-speed mixer (manufactured by FILMIX Corporation, trade name “CLEARMIX” or the like), whereby the conductive pigment paste can be prepared.

The order of mixing of the components is not particularly limited.

### Pigment Dispersing Resin (A)

The pigment dispersing resin (A) preferably has at least one alkyl group having 12 or more carbon atoms. The alkyl group having 12 or more carbon atoms may be any alkyl group (hydrocarbon group) known per se, and is preferably a linear or branched alkyl group, more preferably a linear alkyl group.

The alkyl group having 12 or more carbon atoms is preferably an alkyl group having 12 or more and less than 30 carbon atoms, more preferably an alkyl group having 15 or more and less than 26 carbon atoms, still more preferably an alkyl group having 19 or more and less than 24 carbon atoms. The alkyl group having 12 or more carbon atoms can be introduced into the resin by, for example, (co)polymerizing a polymerizable monomer containing the alkyl group having 12 or more carbon atoms.

Examples of the polymerizable monomer containing the alkyl group having 12 or more carbon atoms include lauryl (meth)acrylate, stearyl (meth)acrylate, isostearyl (meth)acrylate, behenyl (meth)acrylate, lauryl (meth)acrylamide, stearyl (meth)acrylamide, and behenyl (meth)acrylamide. These can be used alone or in combination of two or more.

It is considered that when the pigment dispersing resin (A) has the alkyl group having 12 or more carbon atoms, a relatively bulky side chain, steric repulsion improves pigment dispersibility and storage stability.

The pigment dispersing resin (A) preferably has at least one polar functional group selected from the group consisting of an amide group, an imide group, a hydroxyl group, a carboxyl group, a sulfonic acid group, a phosphoric acid group, a silanol group, a cyano group, a pyrrolidone group, and an amino group. When the pigment dispersing resin (A) has a polar functional group, the concentration of the polar functional group is preferably 0.3 mmol/g or more and 23 mmol/g or less. The above acid groups may be in salt form.

In particular, as the polar functional group, it is preferable to use at least an amide group, a hydroxyl group, a carboxyl group, a sulfonic acid group, a phosphoric acid group, and an amino group, and it is more preferable to use at least a hydroxyl group, a carboxyl group, and an amino group.

The resin may be of any type as long as it is a resin other than the fluorocarbon resin (D) described later. Examples include acrylic resins, polyester resins, epoxy resins, polyether resins, alkyd resins, urethane resins, polyvinyl alcohol, polyvinyl acetal, polyvinylpyrrolidone, polyvinyl acetate, silicone resins, polycarbonate resins, chlorine-based resins, and composite resins thereof. These resins can be used alone or in combination of two or more.

In particular, from the viewpoint of, for example, pigment dispersibility, storage stability, and finish quality, the pigment dispersing resin (A) preferably contains a vinyl (co)polymer (A1) obtained by polymerizing or copolymerizing a monomer including a polymerizable unsaturated group-containing monomer represented by the following formula (1), and is particularly preferably an acrylic resin obtained by (co)polymerizing a polymerizable unsaturated group-containing monomer containing at least one (meth)acryloyl group.

The term “(co)polymer” in the present invention is meant to include both a polymer obtained by polymerizing one kind of a monomer and a copolymer obtained by copolymerizing two or more kinds of monomers.

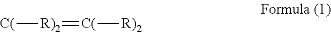

[In the above formula, R's may be the same or different from each other and are each a hydrogen atom or an organic group.]

Examples of the vinyl (co)polymer (A1) include hydroxyl group-containing vinyl (co)polymers, carboxyl group-containing vinyl (co)polymers, amide group-containing vinyl (co)polymers, sulfonic acid group-containing vinyl (co)polymers, phosphoric acid group-containing vinyl (co)polymers, pyrrolidone group-containing vinyl (co)polymers, and amino group-containing (co)polymers. These (co)polymers can be used alone or in combination of two or more.

Examples of the hydroxyl group-containing vinyl (co)polymers include polyhydroxyethyl (meth)acrylate, polyvinyl alcohol, vinyl alcohol-fatty acid vinyl copolymers, vinyl alcohol-ethylene copolymers, vinyl alcohol-(N-vinylformamide) copolymers, and copolymers of hydroxyethyl (meth)acrylate and other polymerizable unsaturated monomers. The vinyl alcohol unit in a (co)polymer may be obtained by (co)polymerization of a fatty acid vinyl unit, followed by hydrolysis.

Examples of the carboxyl group-containing vinyl (co)polymers include polymers of (meth)acrylic acid and copolymers of poly(meth)acrylic acid and other polymerizable unsaturated monomers.

Examples of the amide group-containing vinyl (co)polymers include polymers of (meth)acrylamide and copolymers of (meth)acrylamide and other polymerizable unsaturated monomers.

Examples of the sulfonic acid group-containing vinyl (co)polymers include polymers of allylsulfonic acid, styrenesulfonic acid, and the like and copolymers of allylsulfonic acid and/or styrenesulfonic acid and other polymerizable unsaturated monomers.

Examples of the phosphoric acid group-containing vinyl (co)polymers include polymers of (meth)acryloyloxyalkyl acid phosphate and copolymers of (meth)acryloyloxyalkyl acid phosphate and other polymerizable unsaturated monomers.

Examples of the amino group-containing vinyl (co)polymers include copolymers of N,N-dimethylaminoethyl (meth)acrylate, N,N-diethylaminoethyl (meth)acrylate, and other polymerizable unsaturated monomers.

Examples of the other polymerizable unsaturated monomers that can be copolymerized include vinyl carboxylate ester monomers such as vinyl formate, vinyl acetate, vinyl propionate, isopropenyl acetate, vinyl valerate, vinyl caprylate, vinyl caprate, vinyl laurate, vinyl stearate, vinyl benzoate, vinyl versatate, and vinyl pivalate; olefins such as ethylene, propylene, and butylene; aromatic vinyls such as styrene and α-methylstyrene; ethylenically unsaturated carboxylic acid alkyl ester monomers such as methyl (meth)acrylate, ethyl (meth)acrylate, n-butyl (meth)acrylate, 2-ethylhexyl (meth)acrylate, dimethyl fumarate, dimethyl maleate, diethyl maleate, and diisopropyl itaconate; vinyl ether monomers such as methyl vinyl ether, n-propyl vinyl ether, isobutyl vinyl ether, and dodecyl vinyl ether; vinyl halide monomers and vinylidene halide monomers such as vinyl chloride, vinylidene chloride, vinyl fluoride, and vinylidene fluoride; allyl compounds such as allyl acetate and allyl chloride; and quaternary ammonium group-containing monomers such as 3-(meth)acrylamidepropyltrimethylammonium chloride. These monomers can be used alone or in combination of two or more.

From the viewpoint of pigment dispersibility, storage stability, and compatibility with a solvent, the polar functional group concentration in the pigment dispersing resin (A) is typically 0.3 mmol/g to 23 mmol/g, preferably 0.3 mmol/g to 12 mmol/g, more preferably 0.4 mmol/g to 8.0 mmol/g, still more preferably 0.4 mmol/g to 6.0 mmol/g, further particularly preferably 0.4 mmol/g to 2.0 mmol/g.

The vinyl (co)polymer (A1) can be produced by a polymerization method known per se. For example, it is preferable, but not necessary, to use solution polymerization, and bulk polymerization, emulsion polymerization, suspension polymerization, or the like may also be used. When solution polymerization is performed, continuous polymerization or batch polymerization may be used, and a monomer may be charged in one portion or multiple portions or may be added continuously or intermittently.

The polymerization initiator used in the solution polymerization is not particularly limited, and specifically, for example, a known radical polymerization initiator such as an azo compound such as azobisisobutyronitrile, 2,2′-azobis(2-methylbutyronitrile), azobis-2,4-dimethylvaleronitrile, or azobis(4-methoxy-2,4-dimethylpaleronitrile); a peroxide such as acetyl peroxide, benzoyl peroxide, lauroyl peroxide, acetylcyclohexylsulfonyl peroxide, or 2,4,4-trimethylpentyl-2-peroxyphenoxyacetate; a percarbonate compound such as diisopropyl peroxydicarbonate, di-2-ethylhexyl peroxydicarbonate, or diethoxyethyl peroxydicarbonate; a perester compound such as t-butyl peroxyneodecanoate, α-cumyl peroxyneodecanoate, or t-butyl peroxyneodecanoate; azobisdimethylvaleronitrile, or azobismethoxyvaleronitrile can be used.

The polymerization reaction temperature is not particularly limited, and can be set typically in the range of about 30° C. or higher and 200° C. or lower.

The degree of polymerization of the vinyl (co)polymer (A1) obtainable as described above is, for example, 100 or more, preferably 150 or more, and is, for example, 4,000 or less, preferably 3,000 or less, more preferably 700 or less.

The weight-average molecular weight is, for example, 1,000 or more, preferably 2,000 or more, more preferably 7,000 or more, and is, for example, 2,000, 000 or less, preferably 1,000,000 or less, more preferably 500,000 or less.

Unless otherwise specified, a weight-average molecular weight in this specification is a value obtained by converting a retention time (retention volume) measured using a gel permeation chromatograph (GPC) into a molecular weight of polystyrene by using a retention time (retention volume) of standard polystyrene of known molecular weight measured under the same conditions. Specifically, the weight-average molecular weight can be measured using “HLC8120GPC” (manufactured by Tosoh Corporation, trade name) as a gel permeation chromatograph and four columns: “TSKgel G-4000HXL”, “TSKgel G-3000HXL”, “TSKgel G-2500HXL”, and “TSKgel G-2000HXL” (all manufactured by Tosoh Corporation, trade names), under the following conditions: mobile phase, tetrahydrofuran; measurement temperature, 40° C.; flow rate, 1 mL/min; and detector, RI.

After completion of synthesis, the vinyl (co)polymer (A1) can be subjected to desolvation and/or solvent replacement to be converted into a solid or a resin solution in any replaced solvent.

The desolvation may be performed by heating under normal pressure or may be performed under reduced pressure. In the solvent replacement, a replacement solvent may be supplied at any stage, i.e., before, during, or after the desolvation.

The content of the alkyl group having 12 or more carbon atoms in the dispersing resin (A), in the case of the vinyl (co)polymer (A1), is preferably 1 to 100 mass %, more preferably 10 to 90 mass %, still more preferably 20 to 80 mass %, particularly preferably 30 to 60 mass %, in terms of the mass percentage of the monomer relative to 100 mass of all the monomers.

When a reactive compound having an alkyl group having 12 or more carbon atoms is added to the resin later, the content of the alkyl group having 12 or more carbon atoms is calculated as the mass percentage of this compound.

When the pigment dispersing resin (A) is converted from a solid state into a resin solution, from the viewpoint of solvent solubility, it is preferably mixed and dissolved in advance with a solvent having a liquid temperature of 60° C. or higher (preferably 80° C. or higher) (the upper limit is 200° C. or lower, preferably 100° C. or lower) to be converted into a resin solution and further mixed with other components [e.g., the components (B), (C), and (D)].

The “liquid temperature” is the temperature of the solvent or the resin solution at the time of dissolution.

The pigment dispersing resin (A) in a solid state may be mixed and dissolved in a solvent at 60° C. or higher in advance, or the pigment dispersing resin (A) in a solid state may be mixed with a solvent and then heated to a temperature of 60° C. or higher.

Components other than the pigment dispersing resin (A) and the solvent may be contained.

The solvent for use may be a single solvent or a combination of two or more solvents, and those listed in Solvent (C) given later can be suitably used.

The solid content of the pigment dispersing resin (A) is, for example, 0.1 mass % or more, preferably 1 mass or more, more preferably 3 mass % or more, and is, for example, 40 mass % or less, preferably 30 mass % or less, more preferably 20 mass % or less, based on 100 mass % of the total solid content of the conductive pigment paste.

The solid content of the pigment dispersing resin (A) is, for example, 0.1 mass % or more, preferably 0.4 mass % or more, more preferably 0.7 mass % or more, and is, for example, 10 mass % or less, preferably 5 mass % or less, more preferably 2 mass % or less, based on 100 mass % of the total amount of the conductive pigment paste.

The solid content of the pigment dispersing resin (A) is, for example, 0.1 mass % or more, preferably 1 mass % or more, more preferably 5 mass % or more, and is, for example, 150 mass % or less, preferably 120 mass % or less, more preferably 80 mass % or less, based on 100 mass % of the content of the conductive pigment (B).

### Solvent (C)

As the solvent (C), water, various organic solvents, and the like can be suitably used. Specific examples include hydrocarbon solvents such as n-butane, n-hexane, n-heptane, n-octane, cyclopentane, cyclohexane, and cyclobutane; aromatic solvents such as toluene and xylene; ketone solvents such as methyl isobutyl ketone; ether solvents such as n-butyl ether, dioxane, ethylene glycol monomethyl ether, ethylene glycol monoethyl ether, ethylene glycol monoethyl ether, ethylene glycol monobutyl ether, and diethylene glycol; ester solvents such as ethyl acetate, n-butyl acetate, isobutyl acetate, ethylene glycol monomethyl ether acetate, and butyl carbitol acetate; ketone solvents such as methyl ethyl ketone, methyl isobutyl ketone, and diisobutyl ketone; alcohol solvents such as ethanol, isopropanol, n-butanol, sec-butanol, and isobutanol; and amide solvents such as EQUAMIDE (amide solvent, manufactured by Idemitsu Kosan Co., Ltd., trade name), N,N-dimethylformamide, N,N-dimethylacetamide, N-methylformamide, N-methylacetamide, N-methylpropioamide, and N-methyl-2-pyrrolidone.

In particular, amide solvents are preferred, and N-methyl-2-pyrrolidone is more preferred. These solvents can be used alone or in combination of two or more.

From the viewpoint of the pigment dispersibility of the conductive pigment paste and prevention of modification and hydrolysis of the resin component, the solvent (C) preferably contains substantially no water. The phrase “contains substantially no water” means that the water content is typically 1 mass % or less, preferably 0.5 mass % or less, particularly preferably 0.1 mass % or less, based on 100 mass % of the total amount of the conductive pigment paste.

In the present invention, the water content of the conductive pigment paste can be measured by Karl Fischer coulometric titration. Specifically, it can be measured using a Karl Fischer moisture titrator (manufactured by Kyoto Electronics Manufacturing Co., Ltd., trade name “MKC-610”) with an evaporator (manufactured by Kyoto Electronics Manufacturing Co., Ltd., trade name “ADP-611”) installed in the apparatus being set at a temperature of 130° C.

When an amide compound (solvent) such as N-methyl-2-pyrrolidone is used, an amine component may be contained as an impurity, and in the conductive pigment paste of the present invention, the viscosity or the tendency of viscosity increase may vary from lot to lot depending on the amine component as an impurity.

When the conductive pigment paste of the present invention is formed into an electrode layer by a method described later, the solvent and the like volatilize and thus will not remain, but it is preferable to recover and reuse the volatilized solvent for waste reduction, environmental friendliness, and/or raw material cost reduction. That is, it is preferable to use a regenerated product as the solvent (C). This regenerated solvent (regenerated product) also contains an amine compound (E1) originally contained in the conductive pigment paste of the present invention, and the viscosity or the tendency of viscosity increase of the conductive pigment paste also varies from lot to lot. The amine compound often has a strong odor.

Therefore, the amine compound content in the solvent (C) as a regenerated product is preferably controlled and regulated at or below a certain level, and it is preferable that the amine compound content is typically 1 mass % or less, preferably 0.5 mass % or less, particularly preferably 0.1 mass % or less.

The amine compound content can be quantitatively determined by a commonly used analysis such as ion chromatography-mass spectrometry (IC-MS). The content can be quantitatively determined by preliminarily preparing a calibration curve for the peak of an amine species expected to enter.

The above phrase “use a regenerated product as the solvent (C)” means that the regenerated product is included in an amount of 10 mass % or more (preferably 20 mass % or more) in the solvent (C) used in the conductive pigment paste of the present invention.

The content of the solvent (C) in the conductive pigment paste is, for example, 40 mass % or more, preferably 60 mass % or more, more preferably 80 mass % or more, and is, for example, 99 mass % or less, preferably 98 mass or less, more preferably 97 mass % or less, based on 100 mass % of the total amount of the conductive pigment paste.

The solid content of the conductive pigment paste is, for example, 1 mass % or more, preferably 2 mass % or more, more preferably 3 mass % or more, and is, for example, 60 mass % or less, preferably 40 mass % or less, more preferably 20 mass or less, based on 100 mass % of the total amount of the conductive pigment paste.

### Fluorocarbon Resin (D)

The fluorocarbon resin (D), which is a resin used for the purpose of film formation of an electrode layer, can be optionally contained in the conductive pigment paste, and is preferably contained.

It is a component essential to the mixture paste described later.

As the fluorocarbon resin (D), polyvinylidene fluoride (PVDF) is particularly preferred, and one can be used alone, or two or more can be used in combination. The polyvinylidene fluoride may be variously modified, and preferably has a polar functional group from the viewpoint of adhesion to a substrate.

The fluorocarbon resin (D) may be contained at the time of pigment dispersion or may be incorporated by addition after pigment dispersion. Alternatively, it may be incorporated during the production of the mixture paste described later.

The weight-average molecular weight of the fluorocarbon resin (D) is, for example, 100,000 or more, preferably 500,000 or more, more preferably 650,000 or more, and is, for example, 3,000,000 or less, preferably 2,000, 000 or less, from the viewpoint of adhesion to a substrate, enhancement of film physical properties, and solvent resistance.

The content of the fluorocarbon resin (D), if contained, is, for example, 10.0 mass % or more, preferably 30.0 mass % or more, more preferably 40.0 mass % or more, and is, for example, 99.0 mass % or less, preferably 80.0 mass or less, more preferably 60.0 mass % or less, based on 100 mass % of the solid content of the conductive pigment paste. The content of the fluorocarbon resin (D) is, for example, 0.1 mass % or more, preferably 0.5 mass % or more, more preferably 1 mass % or more, and is, for example, 10 mass % or less, preferably 7 mass % or less, more preferably 5 mass % or less, based on 100 mass % of the total amount of the conductive pigment paste.

When the fluorocarbon resin (D) is converted from a solid state into a resin solution, from the viewpoint of solvent solubility, it is preferably mixed and dissolved in advance with a solvent at a liquid temperature of 40° C. or higher (preferably 60° C. or higher, more preferably 80° C. or higher) (the upper limit is 200° C. or lower, preferably 100° C. or lower) to be converted into a resin solution and further mixed and dispersed with the conductive pigment composition. The “liquid temperature” is the temperature of the solvent or the resin solution at the time of dissolution.

The fluorocarbon resin (D) in a solid state may be mixed and dissolved in a solvent at 40° C. or higher in advance, or the fluorocarbon resin (D) in a solid state may be mixed with a solvent and then heated to a temperature of 40° C. or higher. Components other than the fluorocarbon resin (D) and the solvent may be contained.

When the above thermal dissolution is performed, the fluorocarbon resin (D) is preferably polyvinylidene fluoride (or a modification thereof).

The solvent for use may be a single solvent or a combination of two or more solvents, and those listed in Solvent (C) above can be suitably used.

The resin solution obtained through thermal dissolution as described above is preferably cooled to a predetermined temperature of 10° C. or higher and lower than 40° C., and this cooling step is preferably carried out such that the cooling rate defined by the following formula:

Cooling rate=(solution temperature at the start of cooling−solution temperature at the end of cooling)/cooling time is 0.5° C./min or more (preferably 1° C./min or more) from the viewpoint of preventing precipitation.

### Highly Polar Low-Molecular-Weight Component (E)

The highly polar low-molecular-weight component (E) is a component that increases the wettability and/or storage stability of the conductive pigment, and examples include basic components and acidic components known per se, among which an amine compound (E1) is preferably contained.

The content of the amine compound (E1) in the highly polar low-molecular-weight component (E) is, for example, 50 mass % or more, preferably 75 mass % or more, more preferably 95 mass % or more, based on 100 mass % of the highly polar low-molecular-weight component (E).

Examples of the amine compound (E1) include ammonia, primary amines, secondary amines, and tertiary amines.

Examples of primary amines include primary monoamines such as ethylamine, n-propylamine, sec-propylamine, n-butylamine, sec-butylamine, i-butylamine, tert-butylamine, pentylamine, hexylamine, heptylamine, octylamine, decylamine, laurylamine, myristylamine, 1,2-dimethylhexylamine, 3-pentylamine, 2-ethylhexylamine, allylamine, aminoethanol, 1-aminopropanol, 2-aminopropanol, aminobutanol, aminopentanol, aminohexanol, 3-ethoxypropylamine, 3-propoxypropylamine, 3-isopropoxypropylamine, 3-butoxypropylamine, 3-isobutoxypropylamine, 3-(2-ethylhexyloxy) propylamine, aminocyclopentane, aminocyclohexane, aminonorbornene, aminomethylcyclohexane, aminobenzene, benzylamine, phenethylamine, α-phenylethylamine, naphthylamine, and furfurylamine; and primary polyamines such as ethylenediamine, 1,2-diaminopropane, 1,3-diaminopropane, 1,2-diaminobutane, 1,3-diaminobutane, 1,4-diaminobutane, 1,5-diaminopentane, 1,6-diaminohexane, 1,7-diaminoheptane, 1,8-diaminooctane, dimethylaminopropylamine, diethylaminopropylamine, bis-(3-aminopropyl) ether, 1,2-bis-(3-aminopropoxy) ethane, 1,3-bis-(3-aminopropoxy)-2,2′-dimethylpropane, aminoethylethanolamine, 1,2-bisaminocyclohexane, 1,3-bisaminocyclohexane, 1,4-bisaminocyclohexane, 1,3-bisaminomethylcyclohexane, 1,4-bisaminomethylcyclohexane, 1,3-bisaminoethylcyclohexane, 1,4-bisaminoethylcyclohexane, 1,3-bisaminopropylcyclohexane, 1,4-bisaminopropylcyclohexane, hydrogenated 4,4′-diaminodiphenylmethane, 2-aminopiperidine, 4-aminopiperidine, 2-aminomethylpiperidine, 4-aminomethylpiperidine, 2-aminoethylpiperidine, 4-aminoethylpiperidine, N-aminoethylpiperidine, N-aminopropylpiperidine, N-aminoethylmorpholine, N-aminopropylmorpholine, isophoronediamine, menthanediamine, 1,4-bisaminopropylpiperazine, o-phenylenediamine, m-phenylenediamine, p-phenylenediamine, 2,4-tolylenediamine, 2,6-tolylenediamine, 2,4-toluenediamine, m-aminobenzylamine, 4-chloro-o-phenylenediamine, tetrachloro-p-xylylenediamine, 4-methoxy-6-methyl-m-phenylenediamine, m-xylylenediamine, p-xylylenediamine, 1,5-naphthalenediamine, 2,6-naphthalenediamine, benzidine, 4,4′-bis(o-toluidine), dianisidine, 4,4′-diaminodiphenylmethane, 2,2-(4,4′-diaminodiphenyl) propane, 4,4′-diaminodiphenyl ether, 4,4′-thiodianiline, 4,4′-diaminodiphenylsulfone, 4,4′-diaminoditolylsulfone, methylenebis(o-chloroaniline), 3,9-bis(3-aminopropyl) 2,4,8,10-tetraoxaspiro[5,5]undecane, diethylenetriamine, iminobispropylamine, methyliminobispropylamine, bis(hexamethylene)triamine, triethylenetetramine, tetraethylenepentamine, pentaethylenehexamine, N-aminoethylpiperazine, N-aminopropylpiperazine, 1,4-bis(aminoethylpiperazine), 1,4-bis(aminopropylpiperazine), 2,6-diaminopyridine, and bis (3,4-diaminophenyl) sulfone.

Examples of secondary amines include secondary monoamines such as diethylamine, dipropylamine, di-n-butylamine, di-sec-butylamine, diisobutylamine, di-n-pentylamine, di-3-pentylamine, dihexylamine, dioctylamine, di (2-ethylhexyl)amine, methylhexylamine, diallylamine, pyrrolidine, piperidine, 2,4-lupetidine, 2,6-lupetidine, 3,5-lupetidine, diphenylamine, N-methylaniline, N-ethylaniline, dibenzylamine, methylbenzylamine, dinaphthylamine, pyrrole, indoline, indole, and morpholine; and secondary polyamines such as N,N′-dimethylethylenediamine, N,N′-dimethyl-1,2-diaminopropane, N,N′-dimethyl-1,3-diaminopropane, N,N′-dimethyl-1,2-diaminobutane, N,N′-dimethyl-1,3-diaminobutane, N,N′-dimethyl-1,4-diaminobutane, N,N′-dimethyl-1,5-diaminopentane, N,N′-dimethyl-1,6-diaminohexane, N,N′-dimethyl-1,7-diaminoheptane, N,N′-diethylethylenediamine, N,N′-diethyl-1,2-diaminopropane, N,N′-diethyl-1,3-diaminopropane, N,N′-diethyl-1,2-diaminobutane, N,N′-diethyl-1,3-diaminobutane, N,N′-diethyl-1,4-diaminobutane, N,N′-diethyl-1,6-diaminohexane, piperazine, 2-methylpiperazine, 2,5-dimethylpiperazine, 2,6-dimethylpiperazine, homopiperazine, 1,1-di-(4-piperidyl) methane, 1,2-di-(4-piperidyl) ethane, 1,3-di-(4-piperidyl) propane, and 1,4-di-(4-piperidyl) butane.

Examples of tertiary amines include tertiary monoamines such as trimethylamine, triethylamine, tri-n-propylamine, tri-iso-propylamine, tri-1,2-dimethylpropylamine, tri-3-methoxypropylamine, tri-n-butylamine, tri-iso-butylamine, tri-sec-butylamine, tri-pentylamine, tri-3-pentylamine, tri-n-hexylamine, tri-n-octylamine, tri-2-ethylhexylamine, tri-dodecylamine, tri-laurylamine, dicyclohexylethylamine, cyclohexyldiethylamine, tri-cyclohexylamine, N,N-dimethylhexylamine, N-methyldihexylamine, N,N-dimethylcyclohexylamine, N-methyldicyclohexylamine, N,N-diethylethanolamine, N,N-dimethylethanolamine, N-ethyldiethanolamine, triethanolamine, tribenzylamine, N,N-dimethylbenzylamine, diethylbenzylamine, triphenylamine, N,N-dimethylamino-p-cresol, N,N-dimethylaminomethylphenol, 2-(N,N-dimethylaminomethyl) phenol, N,N-dimethylaniline, N,N-diethylaniline, pyridine, quinoline, N-methylmorpholine, N-methylpiperidine, 2-(2-dimethylaminoethoxy)-4-methyl-1,3,2-dioxaborinane, and 2-, 3-, 4-picoline; and tertiary polyamines such as tetramethylethylenediamine, pyrazine, N,N′-dimethylpiperazine, N,N′-bis((2-hydroxy) propyl) piperazine, hexamethylenetetramine, N,N,N′,N′-tetramethyl-1,3-butaneamine, 2-dimethylamino-2-hydroxypropane, diethylaminoethanol, N,N,N-tris(3-dimethylaminopropyl)amine, 2,4,6-tris(N,N-dimethylaminomethyl) phenol, and heptamethylisobiguanide.

These can be used alone or in combination of two or more.

In particular, primary amine compounds are preferred, and monovalent amine compounds (monoamines) are preferred.

Examples of the amine compound (E1) include alkanolamines, aliphatic amines, alicyclic amines, and aromatic amines, any of which can be suitably used, and aromatic amines are preferred.

Since the amine compound preferably does not remain in an electrode layer after drying, the weight-average molecular weight of the amine compound (E1) is preferably less than 1,000, more preferably 800 or less, still more preferably 500 or less, particularly preferably 350 or less, further particularly preferably 250 or less.

For the same reason, the boiling point of the amine compound is preferably 400° C. or lower, more preferably 300° C. or lower, still more preferably 200° C. or lower.

When the boiling point is low, the amine compound may volatilize during production or storage, and furthermore, from the viewpoint of odors, the lower limit is preferably 50° C. or higher, more preferably 100° C. or higher.

The amine value of the amine compound (E1) is typically 5 mgKOH/g or more, preferably 50 mgKOH/g or more, more preferably 105 mgKOH/g or more, and is typically in the range of 1,000 mgKOH/g or less.

As other highly polar low-molecular-weight components used in combination with the amine compound (E1), for example, acidic highly polar low-molecular-weight components selected from organic acids and inorganic acids can be used alone or in combination of two or more. Furthermore, basic highly polar low-molecular-weight components selected from organic bases and inorganic bases can be used alone or in combination of two or more.

Examples of organic acids include organic carboxylic acids (e.g., formic acid, acetic acid, propionic acid, benzoic acid, and phthalic acid) and organic sulfonic acids (e.g., benzenesulfonic acid), and examples of inorganic acids include hydrochloric acid, sulfuric acid, nitric acid, and phosphoric acid. Acid anhydrides thereof can also be used.

Examples of organic bases include basic components other than amine compounds, and examples of inorganic bases include metal hydroxides (e.g., sodium hydroxide and potassium hydroxide).

It is preferable that the content of the highly polar low-molecular-weight component (E) is, for example, 1 mass % or more, preferably 1.5 mass % or more, more preferably 2 masso or more, and is, for example, 600 mass % or less, preferably 300 mass % or less, more preferably 50 mass % or less, based on 100 mass % of the solid content of the conductive pigment paste.

Based on 100 mass % of the solid content of the conductive pigment (B), the lower limit is, for example, 1 mass % or more, preferably 2 mass % or more, more preferably 5 mass or more. The upper limit is, for example, 1,000 mass % or less, preferably 500 mass % or less, more preferably 50 mass % or less.

Based on 100 mass % of the total amount of the conductive pigment paste, the lower limit is, for example, 0.01 mass % or more, preferably 0.05 mass % or more, more preferably 0.1 mass % or more. The upper limit is, for example, 10 mass % or less, preferably 5 mass % or less, more preferably 1 mass % or less.

The highly polar low-molecular-weight component (E) [particularly, the amine compound (E1)] often has a strong odor and thus may deteriorate the working environment at the time of blending or during the process of drying. In addition, it is generally expensive and thus may lead to an increased cost. Therefore, its content needs to be minimized.

It is preferable that the content ratio of the solvent (C) to the highly polar low-molecular-weight component (E), in terms of the mass ratio of the solvent (C) to the highly polar low-molecular-weight component (E), is typically in the range of 100/0.01 to 100/10, preferably in the range of 100/0.02 to 100/7, more preferably in the range of 100/0.05 to 100/5, still more preferably in the range of 100/0.1 to 100/4.

### Other Components

The conductive pigment paste can further contain other components in addition to the components (A), (B), and (C), and (D) and the component (E) which can be optionally contained.

Examples of the other components include resins other than the pigment dispersing resin (A) and the fluorocarbon resin (D), neutralizers, antifoaming agents, antiseptics, anticorrosives, plasticizers, and pigments other than the conductive pigment (B).

Examples of the pigments other than the conductive pigment (B) include white pigments such as titanium white and zinc white; blue pigments such as cyanine blue and indanthrene blue; green pigments such as cyanine green and verdigris; red pigments such as colcothar and organic red pigments such as azo pigments and quinacridone pigments; and yellow pigments such as titanium yellow, chrome yellow, and organic yellow pigments such as benzimidazolone pigments, isoindolinone pigments, isoindoline pigments, and quinophthalone pigments. These pigments can be used alone or in combination of two or more. These pigments other than the conductive pigment (B) can be used for the purpose of, for example, color adjustment and enhancement of film physical properties without greatly impairing conductivity, and may be dispersed simultaneously with the pigment dispersing resin (A) and the conductive pigment (B) or may be mixed in the form of a pigment or a pigment paste after the pigment dispersing resin (A) and the conductive pigment (B) are dispersed to prepare a paste.

The content of the pigments other than the conductive pigment (B) is preferably 10 mass % or less, more preferably 5 mass % or less, still more preferably 1 mass % or less, particularly preferably substantially zero, based on 100 mass % of all the pigments in the conductive pigment paste.

For the viscosity of the conductive pigment paste, from the viewpoint of, for example, pigment dispersibility and storage stability, the viscosity at a shear rate of 2 s⁻¹ is, for example, less than 5,000 mPa·s, preferably less than 2,500 mPa·s, more preferably less than 1,000 mPa·s, and is, for example, 10 mPa·s or more, preferably 50 mPa·s or more, more preferably 100 mPa·s or more.

The viscosity can be measured using, for example, a cone & plate viscometer (manufactured by HAAKE, trade name “Mars2”, a cone & plate with a diameter of 35 mm and an inclination of 2°).

### [Method for Producing Mixture Paste (for Lithium Ion Secondary Battery)]

### Step 3 (Electrode Active Material Mixing Step)

In the production method according to the present invention, a conductive pigment paste containing a conductive pigment is first prepared through the step 1 and the step 2. Further through a step 3 (electrode active material mixing step), a mixture paste for a lithium ion secondary battery can be produced by mixing the conductive pigment paste with at least one electrode active material (F).

In terms of battery performance, it is preferable that the solid content of the electrode active material (F) is typically 10 mass % or more, preferably 20 mass % or more, and is typically 99 mass % or less, preferably 95 mass % or less, based on 100 mass % of the total amount of the mixture paste. The fluorocarbon resin (D), which is an optional component in the conductive pigment paste, is an essential component in the mixture paste and is always contained.

In terms of battery performance, paste viscosity, etc., it is preferable that the solid content of the fluorocarbon resin (D) is typically 0.05 mass % or more, preferably 0.1 mass % or more, and is typically 10 mass % or less, preferably 2 mass % or less, based on 100 mass % of the total amount of the mixture paste.

In the step 3, the mixing step, the mixture paste can be uniformly mixed using a mixer and a disperser known in the art.

In terms of battery performance, paste viscosity, etc., it is preferable that the solid content of the pigment dispersing resin (A) in the solid of the mixture paste is typically 0.01 mass % or more, preferably 0.05 mass % or more, and is typically 10 mass % or less, preferably 1 mass % or less, based on 100 mass % of the total amount of the mixture paste.

From the viewpoint of storage stability (viscosity increase suppression) of the mixture paste, the mixture paste of the present invention contains the highly polar low-molecular-weight component (E), and at least one amine compound (E1) is preferably contained as the highly polar low-molecular-weight component (E).

Since bringing the highly polar low-molecular-weight component (E) into contact with the conductive pigment (B) (to be wet) and then mixing the electrode active material (F) alleviates aggregation of the conductive pigment (B) and the electrode active material (F), the conductive pigment (B) and the highly polar low-molecular-weight component (E) are mixed first. This order of mixing is preferably included.

In terms of battery performance, it is preferable that the solid content of the conductive pigment (B) in the solid of the mixture paste of the present invention is typically 0.01 mass % or more, preferably 0.05 mass % or more, more preferably 0.1 mass % or more, and is typically 30 mass or less, preferably 10 mass % or less, more preferably 5 mass % or less, based on 100 mass % of the total amount of the mixture paste. In terms of electrode drying efficiency and paste viscosity, it is preferable that the content of the solvent (C) in the mixture paste of the present invention is typically 1 mass % or more, preferably 4 mass % or more, more preferably 7 mass % or more, and is typically 90 mass % or less, preferably 70 mass % or less, more preferably 50 mass % or less, based on 100 mass % of the total amount of the mixture paste.

The mixture paste is suitable for use for a positive electrode or a negative electrode for a lithium ion secondary battery electrode, and is preferably suitable for use for a positive electrode.

### Electrode Active Material (F)

Examples of the electrode active material (F) include lithium composite oxides such as lithium nickel oxide (LiNiO₂), lithium manganese oxide (LiMn₂O₄), lithium cobalt oxide (LiCoO₂), and LiNi_{1/3}CO_{1/3}Mn_{1/3}O₂; lithium iron phosphate (LiFePO₄); sodium composite oxides; and potassium composite oxides. These electrode active materials (F) can be used alone or in combination of two or more. The electrode active material containing lithium iron phosphate is inexpensive and has relatively good cycle characteristics and energy density, and thus can be suitably used.

The particle diameter of the electrode active material is typically 0.5 μm or more, preferably 10.5 μm or more, and is typically 30 μm or less, preferably 20 μm or less.

In terms of battery capacity, battery resistance, etc., it is preferable that the solid content of the electrode active material (F) in 100 mass % of the solid of the mixture paste for a lithium ion secondary battery electrode of the present invention is typically 50 mass or more, preferably 60 mass % or more, and is less than 100 mass.

When the electrode active material (F) is contained in the mixture paste, the viscosity may increase during storage. This is probably because the electrode active material (F) has, on its particle surface, an alkali metal hydroxide (e.g., LiOH, KOH, or NaOH) derived from a raw material and thus aggregates (becomes more viscous) due to the conductive pigment (B) which has an acidic surface. Therefore, the presence of the highly polar low-molecular-weight component (E) [particularly, the amine compound (E1)] in a certain amount or more can suppress the viscosity increase during storage of the mixture paste.

As the electrode active material (F) of the present invention, an electrode active material composite (F-1) obtained by covering at least a part of a surface of the electrode active material (F) with a carbon nanotube can be suitably used.

The composite (F-1) can be obtained by mixing the electrode active material (F), the carbon nanotube, and optional other components (e.g., a solvent and a dispersing resin) in advance, and a drying step can be performed after the mixing as required, so that the carbon nanotube can be more uniformly adsorbed and/or fixed on the electrode active material (F).

Since the carbon nanotube is adsorbed and/or fixed on the surface of the electrode active material, the electrode active material composite (F-1) produced as described above can form a uniform conductive network around the electrode active material.

As the carbon nanotube used in the electrode active material composite (F-1), a carbon nanotube known per se can be used without any particular limitation, and the carbon nanotube mentioned as the carbon nanotube (B1) can be suitably used.

### [Lithium Ion Secondary Battery Electrode]

### Method for Producing Electrode Layer for Lithium Ion Secondary Battery

As described above, an electrode layer (also referred to as an electrode mixture layer or a mixture layer) for a lithium ion secondary battery can be produced by applying a mixture paste for a lithium ion secondary battery to the surface of the core (current collector) of a positive electrode or a negative electrode and drying the mixture paste, and is preferably used particularly for a positive electrode.

The conductive pigment paste obtained by the production method according to the present invention can be used not only as a paste for a mixture layer (electrode layer) but also as a primer layer (also called a functional layer or an adhesive layer) between an electrode core and a mixture layer (electrode layer).

The application of the mixture paste for a lithium ion secondary battery can be carried out by a method known per se using a die coater or the like. The amount of application of the mixture paste for a lithium ion secondary battery is not particularly limited, and can be set so that the thickness of the dried mixture layer will be in the range of, for example, 0.04 mm or more, preferably 0.06 mm or more, and, for example, 0.30 mm or less, preferably 0.24 mm or less. The temperature of the drying step can be appropriately set in the range of, for example, 80° C. or higher, preferably 100° C. or higher, and, for example, 250° C. or lower, preferably 200° C. or lower. The duration of the drying step can be appropriately set in the range of, for example, 5 seconds or more and, for example, 120 minutes or less, preferably 60 minutes or less.

Although the whole or part of the solvent (C) and the highly polar low-molecular-weight component (E) which can be optionally contained volatilize in the drying step, it is preferable to recover and reuse the volatilized components (C) and (E) for waste reduction, environmental friendliness, and/or cost reduction, as described above.

### EXAMPLES

Hereinafter, the present invention will be described more specifically with reference to Examples, but it should be noted that the present invention is not limited to these specific embodiments. In the examples, “parts” means parts by mass, and “%” means mass %.

### [Production of Dispersing Resin]

### Production Example 1

N-Methyl-2-pyrrolidone (note 1) in an amount of 75 parts was added to a reaction vessel equipped with a thermometer, a thermostat, a stirrer, a reflux condenser, and a water separator and heated to 120° C. under a stream of nitrogen. After 120° C. was reached, a mixture of monomer species (100 parts in total) shown in Table 1 below and 2 parts of 2,2′-azobis(2-methylbutyronitrile) was added dropwise over 3 hours. After completion of the addition, the resulting mixture was aged at 120° C. for 30 minutes, and a mixture of 1 part of 2,2′-azobis(2-methylbutyronitrile) and 20 parts of N-methyl-2-pyrrolidone (note 1) was added dropwise over 1 hour. The resulting mixture was further aged at 120° C. for 1 hour and then cooled, and N-methyl-2-pyrrolidone (note 1) was added to obtain an acrylic resin (A1) having a solid content of 50%. The polar functional group concentration was 1.3 mmol/g.
(Note 1) N-methyl-2-pyrrolidone: water content 500 ppm (note 2), amine content 500 ppm (note 2), regenerated product
(Note 2) The water content and the amine content were measured using a Karl Fischer moisture titrator (manufactured by Kyoto Electronics Manufacturing Co., Ltd., trade name “MKC-610”) and ion chromatography (manufactured by Shimadzu Corporation, trade name “prominence HIC-NS”).

### Production Example 2

An acrylic resin (A2) having a solid content of 50% was obtained in the same manner as in Production Example 1 except that monomer species shown in Table 1 below were used.

The weight-average molecular weight values of the obtained resins are shown in Table 1 below. In the table, “Resin A1” means the acrylic resin (A1), and “Resin A2” means the acrylic resin (A2).

TABLE 1

| | | | Production Example | |
|---|---|---|---|---|
| | | | Production | Production |
| | | | Example 1 | Example 2 |
| Dispersing resin name | | | Resin A1 | Resin A2 |
| Monomer | Alkyl group | SLMA | | 40 |
| species | monomer | BEMA | 40 | |
| | Other monomer | St | 40 | 40 |
| | | DMAEMA | 20 | 20 |

| | | |
|---|---|---|
| Weight-average molecular weight | 22000 | 22000 |

The abbreviations of the monomer species in Table 1 above are as follows.
SLMA: Lauryl methacrylate (which has a hydrocarbon group having 12 carbon atoms)
BEMA: Behenyl methacrylate (which has a hydrocarbon group having 22 carbon atoms)
St: Styrene
DMAEMA: N,N-Dimethylaminoethyl methacrylate.

### [Pulverization of Carbon Nanotube (CNT)]

### Production Example 3

Using a continuous dry bead mill “DRYSTAR SDA1” (manufactured by Ashizawa Finetech Ltd.), with zirconia beads (diameter 3.0 mm) at a filling ratio of 70% and a mill peripheral speed of 5.0 m/s, a carbon nanotube (CNT1 (Table 2 below)) was pulverized at a feed rate of 0.5 kg/hr for 1 hour to obtain a pulverized carbon nanotube (C1-1). β/α, where α is the G/D ratio of the carbon nanotube before pulverization, and B is the G/D ratio after pulverization, was 0.97. The G/D ratio was measured by a method described later.

### Production Example 4

Using a continuous dry bead mill “DRYSTAR SDA1” (manufactured by Ashizawa Finetech Ltd.), with zirconia beads (diameter 3.0 mm) at a filling ratio of 70% and a mill peripheral speed of 5.0 m/s, a carbon nanotube (CNT1 (Table 2 below)) was pulverized at a feed rate of 0.5 kg/hr for 2 hours to obtain a pulverized carbon nanotube (C1-2). β/α, where α is the G/D ratio of the carbon nanotube before pulverization, and β is the G/D ratio after pulverization, was 0.95. The G/D ratio was measured by a method described later.

### Production Example 5

Using a continuous dry bead mill “DRYSTAR SDA1” (manufactured by Ashizawa Finetech Ltd.), with zirconia beads (diameter 3.0 mm) at a filling ratio of 70% and a mill peripheral speed of 5.0 m/s, a carbon nanotube (CNT2 (Table 2 below)) was pulverized at a feed rate of 0.5 kg/hr for 2 hours to obtain a pulverized carbon nanotube (C2-2). β/α, where α is the G/D ratio of the carbon nanotube before pulverization, and β is the G/D ratio after pulverization, was 0.95. The G/D ratio was measured by a method described later.

### Production Example 6

Using a continuous dry bead mill “DRYSTAR SDA1” (manufactured by Ashizawa Finetech Ltd.), with zirconia beads (diameter 3.0 mm) at a filling ratio of 70% and a mill peripheral speed of 5.0 m/s, a carbon nanotube (CNT3 (Table 2 below)) was pulverized at a feed rate of 0.5 kg/hr for 1 hour to obtain a pulverized carbon nanotube (C3-1). β/α, where α is the G/D ratio of the carbon nanotube before pulverization, and β is the G/D ratio after pulverization, was 0.97. The G/D ratio was measured by a method described later.

TABLE 2

| | Average | | | | Specific | |
|---|---|---|---|---|---|---|
| | outer | Average | Median | | surface | Acidic group |
| CNT | diameter | length | diameter | G/D | area | content |
| name | (nm) | (μm) | D50 (μm) | ratio | (m2/g) | (mmol/g) |
| CNT1 | 9 | 30 | 40 | 0.9 | 255 | 0.04 |
| CNT2 | 13 | 40 | 40 | 0.9 | 180 | 0.04 |
| CNT3 | 10 | 2 | 200 | 0.9 | 280 | 0.05 |

The above carbon nanotubes are all multi-walled carbon nanotubes.

The median diameter (D50), the G/D ratio, the specific surface area (BET specific surface area), and the acidic group content in Table 2 above were measured by methods described later.

### [Production of Conductive Pigment Paste and Mixture Paste]

### Example 1A

In a vessel, 5000 parts of N-methyl-2-pyrrolidone (note 1), 200 parts of the pulverized carbon nanotube (C1-2), 80 parts (solid content 40 parts) of polyvinylpyrrolidone (note 3) as a dispersing resin, 1800 parts (solid content 180 parts) of a resin solution (note 4) of KF Polymer W #7300 (manufactured by KUREHA CORPORATION, trade name, polyvinylidene fluoride, weight-average molecular weight 1,000,000), and 25 parts of benzylamine as an amine were mixed under stirring, and the mixture was finally adjusted to a total mass of 10000 parts with N-methyl-2-pyrrolidone (note 1). Subsequently, the mixture was dispersed in a ball mill for 4 hours to produce a conductive pigment paste (A-1).
(Note 3) Polyvinylpyrrolidone: weight-average molecular weight (Mw) 12000, polar functional group concentration 9.0 (mmol/g)
(Note 4) The resin solution of polyvinylidene fluoride was obtained in such a manner that polyvinylidene fluoride and N-methyl-2-pyrrolidone (note 1) were mixed and dissolved at a temperature of 80° C. in advance, and then cooled to 30° C. over 40 minutes.

### Examples 2A to 10A and Comparative Examples 1A to 2A

Conductive pigment pastes (A-2) to (A-12) were obtained in the same manner as in Example 1A except that formulations shown in Table 3 below were used for dispersing resins, carbon nanotubes (CNT), and amines.

In Comparative Examples, a carbon nanotube [CNT1 (C1-0)] that was not pulverized (dry-dispersed) was used.

The results of the evaluation tests of the conductive pigment pastes described later are shown in Table 3 below.

TABLE 3

| | | Example•Comparative Example | | | | | | | | | | | |
|---|---|---|---|---|---|---|---|---|---|---|---|---|---|
| | | | | | | | | | | | | Comparative | |
| | | Example | | | | | | | | | | Example | |
| | | 1A | 2A | 3A | 4A | 5A | 6A | 7A | 8A | 9A | 10A | 1A | 2A |
| Conductive pigment paste name | | A-1 | A-2 | A-3 | A-4 | A-5 | A-6 | A-7 | A-8 | A-9 | A-10 | A-11 | A-12 |
| Dispersing | Polyvinylpyrrolidone | 40 | | | | 40 | | | | 40 | | 40 | |
| resin | Acrylic resin (A1) | | 40 | | | | 40 | 40 | 40 | | 30 | | |
| | Acrylic resin (A2) | | | 40 | | | | | | | | | |
| | Polyvinyl butyral | | | | 40 | | | | | | | | |
| | Polymethyl | | | | | | | | | | | | 40 |
| | methacrylate | | | | | | | | | | | | |
| CNT | C1-2 | 200 | 200 | 200 | 200 | | | 200 | | | | | |
| | C1-1 | | | | | 200 | 200 | | | | | | |
| | C1-0 | | | | | | | | | | | 200 | 200 |
| | C2-2 | | | | | | | | 200 | | 200 | | |
| | C3-1 | | | | | | | | | 200 | | | |
| Amine | Benzylamine | 25 | 25 | 25 | 25 | 25 | 25 | | | 20 | | | 25 |
| | Aminomethyl | | | | | | | | 25 | | 25 | 25 | |
| | propanol | | | | | | | | | | | | |
| Evaluation | Dispersibility | B | A | A | B | B | A | B | A | B | A | C | D |
| | Volume resistivity | A | A | A | A | B | B | A | A | B | A | B | D |
| | (conductivity) | | | | | | | | | | | | |
| | Initial viscosity | B | A | B | B | B | A | A | A | B | B | C | D |

The amount of dispersing resins in Table 3 above is on a solid basis.

The composition of dispersing resins in Table 3 above is as follows.
Polyvinyl butyral: average degree of polymerization 600, hydroxyl group content 12 mol %, butyral group content 87 mol %, acetyl group content 1 mol %, polar functional group concentration 1.0 (mmol/g)
Polymethyl methacrylate: weight-average molecular weight 20000, homopolymer of methyl methacrylate, polar functional group concentration 0 (mmol/g).

The boiling points and molecular weights of amines in Table 3 above are as follows.
Benzylamine: boiling point 185° C., molecular weight 107
Aminomethyl propanol: boiling point 166° C., molecular weight 89.

### Example 1B

Using a Disper, 100 parts of the conductive pigment paste (A-1) was mixed with 900 parts of electrode active material particles (spinel-structured lithium nickel manganese oxide particles represented by a compositional formula LiNi_{0.5}Mn_{1.5}O₄, average particle diameter 6 μm, BET specific surface area 0.7 m²/g) to produce a mixture paste (B-1).

### Examples 2B to 10B and Comparative Examples 1B to 2B

Mixture pastes (B-2) to (B-12) were obtained in the same manner as in Example 1B except that formulations shown in Table 4 below were used.

The results of the evaluation tests of the mixture pastes described later are shown in Table 3 above.

TABLE 4

| | Example•Comparative Example | | | | | | | | | | | |
|---|---|---|---|---|---|---|---|---|---|---|---|---|
| | | | | | | | | | | | Comparative | |
| | Example | | | | | | | | | | Example | |
| | 1B | 2B | 3B | 4B | 5B | 6B | 7B | 8B | 9B | 10B | 1B | 2B |
| Mixture paste name | B-1 | B-2 | B-3 | B-4 | B-5 | B-6 | B-7 | B-8 | B-9 | B-10 | B-11 | B-12 |
| Conductive pigment | A-1 | A-2 | A-3 | A-4 | A-5 | A-6 | A-7 | A-8 | A-9 | A-10 | A-11 | A-12 |
| paste name | | | | | | | | | | | | |

### <Median Diameter (D50)>

The measurement of a median diameter (D50) was carried out using a laser diffraction/scattering particle diameter distribution analyzer “LA-960” (manufactured by HORIBA, Ltd., trade name) according to the following procedure.

### [Preparation of Aqueous Dispersion Medium]

To 100 mL of distilled water, 0.10 g of F10MC (manufactured by NIPPON PAPER INDUSTRIES CO., LTD., trade name, sodium carboxymethyl cellulose (hereinafter also referred to as CMCNa)) was added, and dissolved by stirring at normal temperature for 24 hours or more to prepare an aqueous dispersion medium containing 0.1 mass % of CMCNa.

### [Preparation of Aqueous CMCNa Solution]

To 100 mL of distilled water, 2.0 g of F10MC (manufactured by NIPPON PAPER INDUSTRIES CO., LTD., trade name, sodium carboxymethyl cellulose) was added, and dissolved by stirring at normal temperature for 24 hours or more to prepare an aqueous solution containing 2.0 mass % of CMCNa.

### [Pre-Measurement Treatment]

Into a vial, 6.0 mg of a carbon nanotube was weighed, and 6.0 g of the aqueous dispersion medium was added. An ultrasonic homogenizer (manufactured by Microtech Nichion, Co. Ltd., “SmurtNR-50”) was used for the pre-measurement treatment. After confirming that there was no deterioration of a tip, the tip was adjusted so as to be immersed 10 mm or more below the surface of the sample liquid to be treated. With TIME SET (irradiation time) set to 40 seconds, POW SET to 50%, and START POW to 50% (output 50%), the sample liquid was homogenized by ultrasonic irradiation under an auto-power operation with constant output power, thereby preparing an aqueous carbon nanotube dispersion.

### [Measurement]

Using the aqueous carbon nanotube dispersion, the measurement of the proportion of dispersed particles of 1 μm or less and the median diameter (D50) of the carbon nanotube was performed according to the following method.

An optical model of LS 13 320 Universal Liquid Module was set to refractive indexes of 1.520 (carbon nanotube) and 1.333 (water), and after completion of cleaning of the module, about 1.0 mL of the aqueous CMCNa solution was introduced.

After offset measurement, optical axis adjustment, and background measurement were performed at a pump speed of 50%, the prepared aqueous carbon nanotube dispersion was added to a particle size distribution analyzer such that the relative concentration indicating the percentage of light scattered outside the beam by the particles was 8% to 12%, or the PIDS was 40% to 55%. Ultrasonic irradiation (pre-measurement treatment) was performed at 78 W for 2 minutes using a particle size distribution analyzer accessory device, and after circulation was performed for 30 seconds to remove bubbles, particle size distribution measurement was performed. A graph of volume percent versus particle size (particle diameter) was obtained, and the proportion of dispersed particles of 1 μm or less and the median diameter (D50) were determined.

The measurement was carried out as follows: for one carbon nanotube specimen, three measurement samples were collected at different collection points and subjected to particle size distribution measurement, and the proportion of dispersed particles of 1 μm or less and the median diameter (D50) were determined as their average values.

### <G/D Ratio of Carbon Nanotube>

The Raman spectrum of a carbon nanotube was measured by placing the carbon nanotube in a Raman microscope (manufactured by Horiba, Ltd., trade name “XploRA”) and using a laser wavelength of 532 nm. Among the obtained peaks in the spectrum, the maximum peak intensity within the range of 1560 cm⁻¹ or more and 1600 cm⁻¹ or less was defined as G, and the maximum peak intensity within the range of 1310 cm⁻¹ or more and 1350 cm⁻¹ or less was defined as D. The ratio of G/D was determined as the G/D ratio of the carbon nanotube.

### <Specific Surface Area (BET Specific Surface Area)>

For the BET specific surface area of a carbon nanotube, the BET specific surface area (m²/g) was measured in accordance with JIS Z 8830:2013 using a specific surface area meter (BERSORP-MAX (MicrotracBEL Corp.)).

### <Acidic Group Content of Carbon Nanotube (CNT)>

A CNT was accurately weighed to 2 g, immersed in 50 ml of a 0.01 M benzylamine/n-methylpyrrolidone solution, and subjected to dispersion treatment for 1 hour using an ultrasonic irradiator. Thereafter, centrifugation was performed, and the supernatant was filtered through a filter. The benzylamine remaining in the obtained filtrate was quantitatively analyzed by potentiometric titration using 0.1 M hydrochloric acid to determine the acidic group content (mmol/g) per gram of the obtained CNT.

### Evaluation Tests

The conductive pigment pastes and the mixture pastes obtained in Examples and Comparative Examples above were subjected to evaluation tests. If there is even one unacceptable evaluation result, the evaluation is unacceptable.

### <Dispersibility>

The obtained conductive pigment pastes were evaluated for dispersibility according to the following criteria using a fineness gauge in accordance with the fineness of grind test of JIS K-5600-2-5. C and D are unacceptable.
A: The pigment is dispersed at less than 10 μm. The dispersibility is very good.
B: The pigment is dispersed at 10 μm or more and less than 20 μm. The dispersibility is somewhat good.
C: The pigment is dispersed at 20 μm or more, but no aggregates are visually observable. The dispersibility is somewhat poor.
D: Aggregates are visually observable. The dispersibility is very poor.

### <Volume Resistivity (Conductivity)>

For the obtained conductive pigment pastes, the measurement of volume resistivity was further performed. In the measurement of volume resistivity, a 5 mass % polyvinylidene fluoride solution (manufactured by KUREHA CORPORATION, trade name “KF Polymer W #7300”, solvent: N-methyl-2-pyrrolidone) was used as a binder.

The conductive pigment paste and the KF Polymer W #7300 solution were weighed out such that the ratio of the mass of the conductive pigment (B) in the obtained conductive pigment paste to the total mass of the solid content of the pigment dispersing resin (A) and the solid content of KF Polymer W #7300 in the conductive pigment paste was 5:100, and mixed for 2 minutes using an ultrasonic homogenizer to obtain a measurement sample.

The measurement sample was applied onto a glass plate (2 mm×100 mm×150 mm) by doctor blading, and dried by heating at 80° C. for 60 minutes to form a coating film on the glass plate. After the film thickness of the obtained coating film was measured, the resistance value was measured with a resistivity meter (manufactured by Mitsubishi Chemical Analytech Co., Ltd., trade name “Loresta-GP MCP-T610”) using an ASP probe (manufactured by Mitsubishi Chemical Analytech Co., Ltd., trade name “MCP-TP03P”), and the obtained resistance value was multiplied by a resistivity correction factor (RCF) of 4.532 and the film thickness of the coating film to calculate the volume resistivity. The volume resistivity was evaluated according to the following criteria. D is unacceptable.
A: The volume resistivity is less than 7 Ω·cm, and the conductivity is good.
B: The volume resistivity is 7 Ω·cm or more and less than 15 Ω·cm, and the conductivity is fair.
D: The volume resistivity is 15 Ω·cm or more, and the conductivity is poor.

### <Initial Viscosity>

Using a cone & plate viscometer (manufactured by HAAKE, trade name “Mars2”, a cone & plate with a diameter of 35 mm and an inclination of 2°), the viscosity of the obtained mixture paste was measured at a shear rate of 2.0 sec⁻¹ and evaluated according to the following criteria. D is unacceptable.
A: The viscosity is less than 10 Pa·s.
B: The viscosity is 10 Pa·s or more and less than 20 Pa·s.
C: The viscosity is 20 Pa·s or more and less than 50 Pa·s.
D: The viscosity is 50 Pas or more

### [Production of Battery Electrode Layer]

### Application Examples 1C to 10C

The mixture paste obtained in each of Examples 1B to 10B was applied to both sides of a long aluminum foil (positive electrode current collector) having an average thickness of 15 μm in a strip shape by roller coating such that the coating weight per side was 10 mg/cm² (on a solid basis), and dried (at a drying temperature of 180° C. for 10 minutes), thereby forming a positive electrode layer. The positive electrode active material layer (positive electrode layer) supported on the positive electrode current collector was rolled with a roll press machine to adjust the shape. The obtained electrode layer had a residual solvent amount of less than 1% and was an electrode layer satisfactory in finish quality, etc.

1. A method for producing a conductive pigment paste containing a pigment dispersing resin (A), a conductive pigment (B), a solvent (C), and a fluorocarbon resin (D) that can be included as needed, the method being characterized by comprising a step of sequentially performing
Step 1: a step of pulverizing a conductive pigment composition containing the conductive pigment (B) at a pigment concentration of 50 mass % or more with a pulverizer, and
Step 2: a step of mixing the conductive pigment composition obtained in Step 1 with components including the pigment dispersing resin (A), the solvent (C), and the fluorocarbon resin (D) that can be included as needed, and performing dispersion.

2. The method for producing a conductive pigment paste according to claim 1, characterized in that the conductive pigment (B) contains a carbon nanotube (B1).

3. The method for producing a conductive pigment paste according to claim 2, wherein the carbon nanotube (B1) before and after the pulverizing in the step 1 satisfies (1) and (2) below;
(1) a G/D ratio of the carbon nanotube (B1) before the pulverizing, where G is a maximum peak intensity in a range of 1560 cm⁻¹ or more and 1600 cm⁻¹ or less, and D is a maximum peak intensity in a range of 1310 cm⁻¹ or more and 1350 cm⁻¹ or less, is 0.1 or more and 5.0 or less,
(2) when the G/D ratio of the carbon nanotube (B1) before the pulverizing is a, and a G/D ratio of the carbon nanotube (B1) after the pulverizing is β, β/α<1.00 holds.

4. The method for producing a conductive pigment paste according to claim 1, characterized in that the pigment dispersing resin (A) has at least one alkyl group having 12 or more carbon atoms.

5. The method for producing a conductive pigment paste according to claim 1, characterized in that the pigment dispersing resin (A) has at least one polar functional group selected from the group consisting of an amide group, an imide group, a hydroxyl group, a carboxyl group, a sulfonic acid group, a phosphoric acid group, a silanol group, a cyano group, a pyrrolidone group, and an amino group, and the pigment dispersing resin (A) has a polar functional group concentration of 0.3 mmol/g to 23 mmol/g.

6. The method for producing a conductive pigment paste according to claim 1, characterized in that the conductive pigment paste contains the fluorocarbon resin (D), and a step of mixing the fluorocarbon resin (D) includes a step of mixing and dissolving the fluorocarbon resin (D) in advance with a solvent having a liquid temperature of 40° C. or higher or includes a step of mixing the fluorocarbon resin (D) with a solvent and then performing heating to a temperature of 40° C. or higher.

7. The method for producing a conductive pigment paste according to claim 1, characterized in that the solvent (C) is N-methyl-2-pyrrolidone.

8. The production method according to claim 1, characterized in that Step 2 includes a step of sequentially performing
Step 2-1: a step of adding components into a disperser, the components including the conductive pigment composition in an amount of 70 mass % or less based on 100 mass % of a total amount of the conductive pigment composition contained in a conductive pigment paste obtained after the dispersion, and performing dispersion treatment, and
Step 2-2: a step of adding the conductive pigment composition into the disperser until a desired concentration is reached, and performing dispersion treatment.

9. A method for producing a mixture paste for a lithium ion secondary battery, the method being characterized by further comprising
Step 3: a step of mixing at least one electrode active material (F)
with the conductive pigment paste obtained by the method for producing a conductive pigment paste according to claim 1.

10. A method for producing an electrode layer for a lithium ion secondary battery, the method comprising a step of applying the mixture paste for a lithium ion secondary battery obtained by the production method according to claim 9 to a current collector.

11. A method for producing an electrode for a lithium ion secondary battery, the method comprising a step of applying an electrode insulating portion to an end portion or an upper layer of the electrode layer obtained by the method for producing an electrode layer for a lithium ion secondary battery according to claim 10.

12. A method for producing a mixture paste for a lithium ion secondary battery, the method being characterized by further comprising
Step 3: a step of mixing at least one electrode active material (F)
with the conductive pigment paste obtained by the method for producing a conductive pigment paste according to claim 2.

13. A method for producing a mixture paste for a lithium ion secondary battery, the method being characterized by further comprising
Step 3: a step of mixing at least one electrode active material (F)
with the conductive pigment paste obtained by the method for producing a conductive pigment paste according to claim 3.

14. A method for producing a mixture paste for a lithium ion secondary battery, the method being characterized by further comprising
Step 3: a step of mixing at least one electrode active material (F)
with the conductive pigment paste obtained by the method for producing a conductive pigment paste according to claim 4.

15. A method for producing a mixture paste for a lithium ion secondary battery, the method being characterized by further comprising
Step 3: a step of mixing at least one electrode active material (F)
with the conductive pigment paste obtained by the method for producing a conductive pigment paste according to claim 5.

16. A method for producing a mixture paste for a lithium ion secondary battery, the method being characterized by further comprising
Step 3: a step of mixing at least one electrode active material (F)
with the conductive pigment paste obtained by the method for producing a conductive pigment paste according to claim 6.

17. A method for producing a mixture paste for a lithium ion secondary battery, the method being characterized by further comprising
Step 3: a step of mixing at least one electrode active material (F)
with the conductive pigment paste obtained by the method for producing a conductive pigment paste according to claim 7.

18. A method for producing a mixture paste for a lithium ion secondary battery, the method being characterized by further comprising
Step 3: a step of mixing at least one electrode active material (F)
with the conductive pigment paste obtained by the method for producing a conductive pigment paste according to claim 8.
